(19) United States
(12) Patent Application Publication
(10) Pub. No.: US 2026/0044860 A1
(43) Pub. Date: Feb. 12, 2026

(54) SYSTEM AND METHOD FOR AUTOMATED BALANCE SPENDING

(71) Applicant: FSA Store Inc., Dallas, TX (US)

(72) Inventors: Bhargav Shah, Southlake, TX (US); James Edward Budnik, Salt Lake City, UT (US)

(21) Appl. No.: 19/293,049

(22) Filed: Aug. 7, 2025

Related U.S. Application Data
(60) Provisional application No. 63/681,285, filed on Aug. 9, 2024.

(51) Int. Cl. G06Q 20/40; G06Q 30/0601

(52) U.S. Cl. CPC G06Q 20/405; G06Q 30/06313; G06Q 30/06331

(57) ABSTRACT

A method for automatically spending a balance of an account, including determining that a remaining balance of the account is greater than a predetermined threshold, determining a spending balance, determining that a first item on a purchase list is affordable, scheduling a first order to purchase the first item, and sending a first notification of the first order to a user.

### CROSS-REFERENCE TO RELATED APPLICATIONS

This application claims the benefit under 35 U.S. C. § 119(e) of U.S. Provisional Application No. 63/681,285, filed Aug. 9, 2024, which application is incorporated herein by reference in its entirety.

### FIELD

The present disclosure relates generally to e-commerce, and more particularly, to e-commerce transactions that automatically spend funds prior to a deadline.

### BACKGROUND

A flexible spending account (FSA), also known as a flexible spending arrangement, is one of a number of tax-advantaged financial accounts, resulting in payroll tax savings. The most common type of flexible spending account, the medical expense FSA (also medical FSA or health FSA), is similar to a health savings account (HSA) or a health reimbursement account (HRA). Paper forms or an FSA debit card may be used to access the account funds. FSAs generally have a “use it or lose it” provision wherein a user must use the money in an FSA within the plan year. FSAs may offer a grace period following the end of the plan year in which the money may be used, or allow for a carryover amount into the new plan year. However often times money in an FSA goes unused and thus wasted.

### SUMMARY

According to aspects illustrated herein, there is provided a method for automatically spending a balance of an account, comprising determining that a remaining balance of the account is greater than a predetermined threshold, determining a spending balance, determining that a first item on a purchase list is affordable, scheduling a first order to purchase the first item, and sending a first notification of the first order to a user.

In an exemplary embodiment, the method further comprises determining that the first item on the purchase list is not affordable, determining that a subsequent item on the purchase list is affordable, scheduling a second order to purchase the subsequent item, and sending a second notification of the second order item to the user. In an exemplary embodiment, the method further comprises determining that the first item on the purchase list is not affordable, determining that all subsequent items on the purchase list are not affordable, finding a relatable affordable item, scheduling a second order to purchase the relatable affordable item, and sending a second notification of the second order to the user.

In an exemplary embodiment, the step of finding the relatable affordable item comprises determining that a previously purchased item is a repurchasable item, and determining that the cost of the previously purchased item is less than or equal to the spending balance. In an exemplary embodiment, the step of determining the spending balance comprises determining a carryover amount, and subtracting the carryover amount from the remaining balance.

In an exemplary embodiment, the method further comprises calculating a spending deadline associated with the account, determining an initiation date, wherein the initiation date occurs prior to the spending deadline, and initiating the step of determining that the remaining balance of the account is greater than the predetermined threshold on the initiation date. In an exemplary embodiment, the step of calculating the spending deadline comprises determining a plan year end date, and adding a plan grace period to the plan year end date. In an exemplary embodiment, the account is a flexible spending account.

According to aspects illustrated herein, there is provided a computer program product for automatically spending the balance of an account, comprising a computer readable storage medium and program instructions stored on the computer readable storage medium, the program instructions comprising program instructions to determine that a remaining balance of the account is greater than a predetermined threshold, program instructions to determine a spending balance, program instructions to determine that a first item on a purchase list is affordable, program instructions to schedule a first order to purchase the first item, and program instructions to send a first notification of the first order to a user.

In an exemplary embodiment, the program instructions further comprise program instructions to determine that the first item on the purchase list is not affordable, program instructions to determine that a subsequent item on the purchase list is affordable, program instructions to schedule a second order to purchase the subsequent item, and program instructions to send a second notification of the second order item to the user. In an exemplary embodiment, the program instructions further comprise program instructions to determine that the first item on the purchase list is not affordable, program instructions to determine that all subsequent items on the purchase list are not affordable, program instructions to find a relatable affordable item, program instructions to schedule a second order to purchase the relatable affordable item, and program instructions to send a second notification of the second order to the user. In an exemplary embodiment, the program instructions to find the relatable affordable item comprise program instructions to determine that a previously purchased item is a repurchasable item, and program instructions to determine that the cost of the previously purchased item is less than or equal to the spending balance.

In an exemplary embodiment, the program instructions to determine the spending balance comprise program instructions to determine a carryover amount, and program instructions to subtract the carryover amount from the remaining balance. In an exemplary embodiment, the program instructions further comprise program instructions to calculate a spending deadline associated with the account, program instructions to determine an initiation date, wherein the initiation date occurs prior to the spending deadline, and program instructions to initiate the step of determining that the remaining balance of the account is greater than the predetermined threshold on the initiation date. In an exemplary embodiment, the program instructions to calculate the spending deadline comprise program instructions to determine a plan year end date, and program instructions to add a plan grace period to the plan year end date.

According to aspects illustrated herein, there is provided a computer system for automatically spending the balance of an account, comprising one or more computer processors, one or more computer readable storage media, and program instructions stored on the computer readable storage media for execution by at least one of the one or more computer processors, the program instructions comprising program instructions to determine that a remaining balance of the account is greater than a predetermined threshold, program instructions to determine a spending balance, program instructions to determine that a first item on a purchase list is affordable, program instructions to schedule a first order to purchase the first item, and program instructions to send a first notification of the first order to a user.

In an exemplary embodiment, the program instructions further comprise program instructions to determine that the first item on the purchase list is not affordable, program instructions to determine that a subsequent item on the purchase list is affordable, program instructions to schedule a second order to purchase the subsequent item, and program instructions to send a second notification of the second order item to the user. In an exemplary embodiment, the program instructions further comprise program instructions to determine that the first item on the purchase list is not affordable, program instructions to determine that all subsequent items on the purchase list are not affordable, program instructions to find a relatable affordable item, program instructions to schedule a second order to purchase the relatable affordable item, and program instructions to send a second notification of the second order to the user.

In an exemplary embodiment, the program instructions to find the relatable affordable item comprise program instructions to determine that a previously purchased item is a repurchasable item, and program instructions to determine that the cost of the previously purchased item is less than or equal to the spending balance. In an exemplary embodiment, the program instructions to determine the spending balance comprise program instructions to determine a carryover amount, and program instructions to subtract the carryover amount from the remaining balance.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a functional block diagram illustrating an environment, in accordance with some embodiments of the present disclosure.

FIG. 2 is a flow chart depicting operational steps for automated balance spending.

FIG. 3 is a flow chart depicting operational steps for determining product list priority.

FIG. 4 is a flow chart depicting operational steps for automated balance spending including the application of a courtesy discount.

FIG. 5 is a block diagram of internal and external components of a computer system, in accordance with an exemplary embodiment of the present disclosure.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element. A similar interpretation is intended when the phrase “used in at least one of:” is used herein.

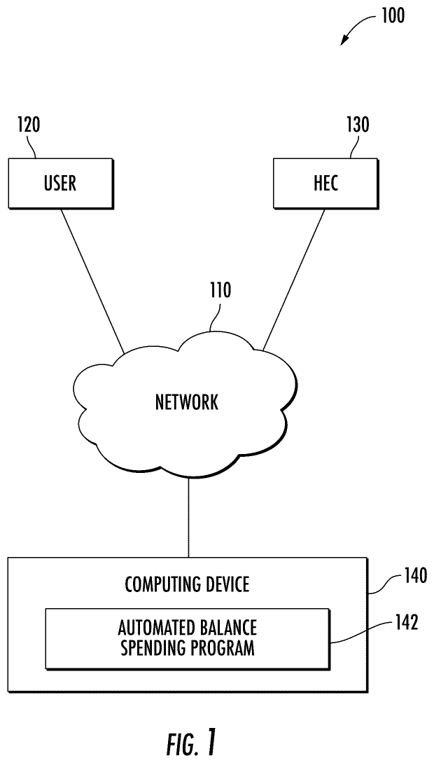

Referring now to the figures, FIG. 1 is a functional block diagram illustrating an automated balance spending environment, generally designated 100, in accordance with one embodiment of the present disclosure. FIG. 1 provides only an illustration of one implementation, and does not imply any limitations with regard to the environments in which different embodiments may be implemented. Many modifications to the depicted environment may be made by those skilled in the art without departing from the scope of the disclosure as recited by the claims. In an exemplary embodiment, environment 100 includes health e-commerce (HEC) retailer or e-commerce retailer 130 and computing device 140 all of which are connected to network 110. In an exemplary embodiment, network 110 further comprises user 120 capable of communicating with network 110.

Network 110 can be, for example, a local area network (LAN), a wide area network (WAN) such as the Internet, or a combination of the two, and can include wired, wireless, or fiber optic connections.

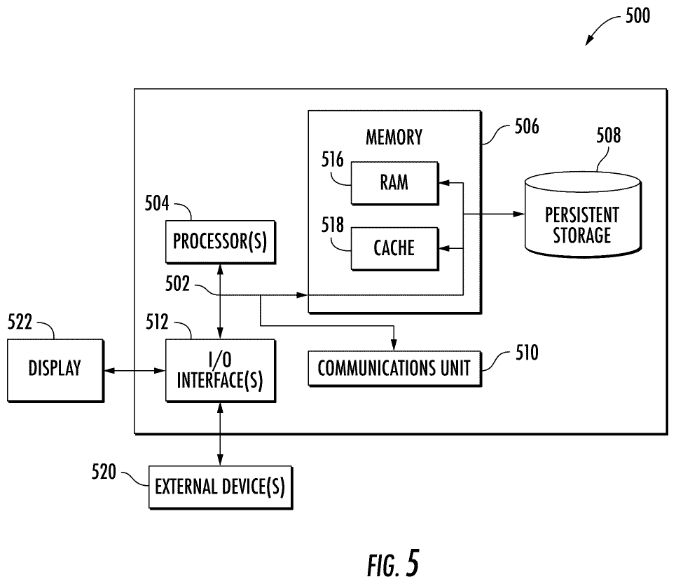

Computing device 140 may be a hardware device that receives data related to a user and communicates with various entities and components to automatically spend the user's account balance before a deadline (e.g., the last day of the plan year) without the need for real time user input, using automated balance spending program 142. Computing device 140 is capable of communicating with network 110, user 120, and/or HEC retailer 130. In an exemplary embodiment, computing device 140 may include a computer. In an exemplary embodiment, computing device 140 may include internal and external hardware components, as depicted and described in further detail with respect to FIG. 5. In an exemplary embodiment, automated balance spending program 142 is implemented on a web server, which may be a management server, a web server, or any other electronic device or computing system capable of receiving and sending data. The web server can represent a computing system utilizing clustered computers and components to act as a single pool of seamless resources when accessed through a network. In an exemplary embodiment, the web server can be hosted either in-house or with a third party cloud services provider. The web server may include internal and external hardware components, as depicted and described in further detail with respect to FIG. 5.

Automated balance spending program 142 can coordinate input from multiple entities, for example, user 120 and HEC retailer 130, and automatically spend a remaining balance for user 120 without the need for the user to manually enter the purchase transactions.

HEC retailer 130 is a health-E commerce retailer of products eligible for purchase using FSA, HSA, or other such tax-advantaged consumer-directed health plan (CDHP) accounts. In an exemplary embodiment, e-commerce retailer 130 is any e-commerce seller of products.

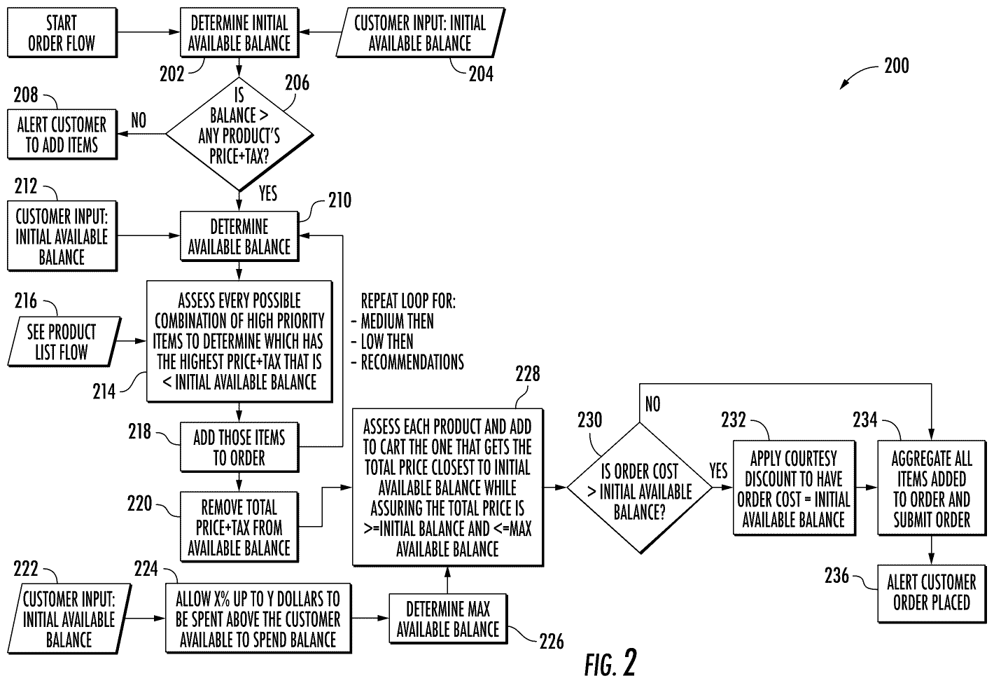

FIG. 2 shows flow chart 200 depicting operational steps for automated balance spending.

In step 202, automated balance spending program 142 determines an initial available balance or remaining balance. Specifically, automated balance spending program 142 determines the initial remaining balance of user 120.

In an exemplary embodiment, in order to determine the initial remaining balance, in step 204, automated balance spending program 142 receives an input from user 120 indicating the initial remaining balance. This input may be manual (e.g., inputted by user 120 via a graphic user interface (GUI)) or automatic (e.g., automated balance spending program 142 pulls the initial remaining balance of user 120).

In step 206, automated balance spending program 142 determines if the initial remaining balance is greater than a predetermined threshold. Specifically, automated balance spending program 142 determines if user 120 has an initial remaining balance that is greater than a minimum amount, for example, the total of the price of any product on an item list plus the sales tax. In this context, the initial remaining balance is in an account, such as an FSA, HSA, or other such tax-advantaged CDHP account, that must be used by a deadline. In one example, the predetermined threshold is greater than $0. In another example, the predetermined threshold is an amount that correlates to the most inexpensive item offered by HEC retailer 130 (e.g., $8), and thus sufficient to make a purchase.

In an exemplary embodiment, step 202 and/or step 206 must occur near the deadline. For example, if the plan year ends on December 31, then automated balance spending program 142 will begin on or after an initiation date, for example, December 17 of that same year. Thus, flowchart 200 may include a step before step 202 and/or step 206, wherein automated balance spending program 142 determines that the current date falls on or after the initiation date.

In an exemplary embodiment, automated balance spending program 142 further determines if a grace period exists. For example, if a grace period of three months exists, then automated balance spending program 142 recalculates the deadline, as March 31 of the following year, and the initiation date, as March 17 of the following year.

If, in step 206, automated balance spending program 142 determines that the initial remaining balance is not greater than the predetermined threshold (i.e., less than or equal to the predetermined threshold), then in step 208 automated balance spending program 142 sends an alert or notification to user 120. In an exemplary embodiment, automated balance spending program 142 may send a notification to user 120 to add items of lesser value to the item list, which would thus lower the predetermined threshold in step 206.

If, in step 206, automated balance spending program 142 determines that the initial remaining balance is greater than the predetermined threshold, then in step 210 automated balance spending program 142 determines a spending balance. In an exemplary embodiment, the spending balance is equal to the initial remaining balance. In an exemplary embodiment, the spending balance is equal to the initial remaining balance less any allowed rollover amount. For example, a FSA plan may allow user 120 to rollover $640 of the current plan year into the subsequent plan year. Thus, if the remaining balance was $1,000, then the spending balance would be $360.

In an exemplary embodiment, in order to determine the spending balance, in step 212, automated balance spending program 142 receives an input from user 120 indicating the initial remaining balance and/or the allowed rollover amount. This input may be manual (e.g., inputted by user 120 via a GUI) or automatic (e.g., automated balance spending program 142 pulls the initial remaining balance of user 120 and/or the rollover amount allowed by the plan).

In step 214, automated balance spending program 142 determines if user 120 can afford a first item on a purchase list. A purchase list as described herein may be a user's wish list, or a compilation of items that user 120 has indicated are of interest or desired. The purchase list may be updated over time, saved in a database or other storage means (e.g., cloud storage), and carry over from year to year. In an exemplary embodiment, the purchase list is ranked from most desired to least desired. Automated balance spending program 142 determines if, based on the spending balance, user 120 can afford the first item (i.e., the most desired item) on the purchase list. In an exemplary embodiment, automated balance spending program 142 assesses every possible combination of items to determine which item has the highest cost that is less than the spending balance. If, in step 214, automated balance spending program 142 determines that user 120 cannot afford the first item on the purchase list (i.e., the spending balance is less than the cost of the first item), then automated balance spending program 142 determines if the user can afford the second or a subsequent item on the purchase list. This process will continue for each item on the purchase list until an item is affordable. For example, if user cannot afford the second item on the purchase list, then automated balance spending program 142 will carry out the analysis of this step with respect to the third item, and then the fourth item, and then the fifth item, etc.

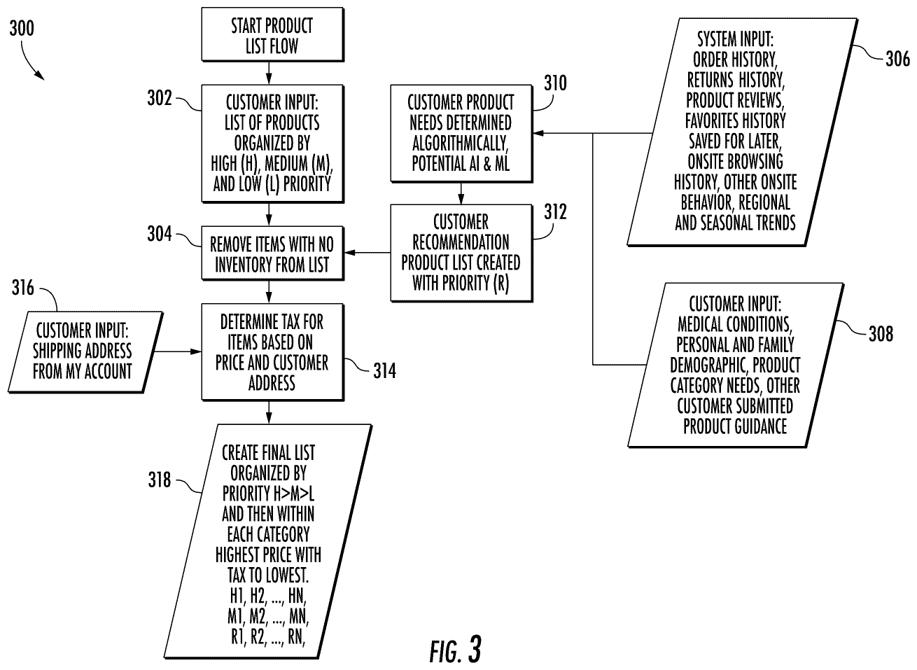

In an exemplary embodiment, in order to determine affordable items on the purchase list or lists, in step 216 automated balance spending program 142 receives one or more purchase lists including items ranked by their priority. Step 216 will be described in greater detail with respect to FIG. 3.

If, in step 214, automated balance spending program 142 determines that user 120 can afford the first item (or subsequent item) on the purchase list (i.e., the spending balance is greater than or equal to the cost of the first item), then in step 218 automated balance spending program 142 adds the first item (or subsequent item) to an order list.

It should be appreciated that in an exemplary embodiment, in step 214, if automated balance spending program 142 determines that user 120 cannot afford the second or any subsequent items on the purchase list (i.e., the spending balance is less than the cost of the subsequent item or items), then automated balance spending program 142 may find a relatable affordable item. A relatable affordable item is one in which user 120 can afford (i.e., the spending balance is greater than or equal to the cost of the relatable affordable item) and relates to the interest of user 120. By relates it is meant that such item may be desired by the user based on past purchases, age, gender, height, weight, medical history (i.e., the user wears eye glasses, has diabetes, has joint problems, etc.), an item related to an item on the purchase list, and/or other factors. In an exemplary embodiment, automated balance spending program 142 determines if an item previously purchased by user 120 is repurchasable. For example, allergy medicine may be determined to be a repurchasable item, and thus automated balance spending program 142 may determine that it is the relatable affordable item. Contrarily, a massage gun may be determined to be a non-repurchasable item, since a user would most likely not need two massage guns, and thus automated balance spending program 142 may determine that it is not the relatable affordable item.

In step 220, automated balance spending program 142 removes the cost of the first item (i.e., the price of the first item plus tax) from the spending balance. The process then proceeds back to step 210 and continues on to subsequent items on the purchase list until, for example, the spending balance is less than the cost of all remaining items on the purchase list or lists.

It should be appreciated that, in an exemplary embodiment, steps 210-220 may be repeated for multiple purchase lists. For example, a first purchase list may represent high priority items, a second purchase list may represent medium priority items, and a third purchase list may represent low priority items. User 120 may compile multiple lists, where each list has one or more items ranked therein from most desired to least desired and/or from highest cost to lowest cost.

In step 228, automated balance spending program 142 assesses each item added to the order list with respect to a max available balance. Specifically, automated balance spending program 142 selects the item in the order list that has a cost closest to a max available balance while ensuring that the cost is greater than or equal to the spending balance and less than or equal to the max available balance.

To determine the max available balance, in step 224 automated balance spending program 142 determines an amount to be spent above the available spending balance. For example, automated balance spending program 142 may determine that user 120 may spend over the spending balance by a percentage of the spending balance (e.g., 15%) or an amount (e.g., $75).

In an exemplary embodiment, in order to determine an amount to be spent above the available spending balance, in step 222 automated balance spending program 142 receives an input from user 120 indicating the amount to be spent over the available spending balance. This input may be manual (e.g., inputted by user 120 via a GUI) or automatic (e.g., automated balance spending program 142 pulls the amount from the plan).

In step 226, automated balance spending program 142 determines a max available balance. Thus, if user 120 has a spending balance of $1,000, automated balance spending program 142 may determine that the user 120 has a max spending balance of $1,150 (i.e., spending balance plus 15%) or $1,075 (i.e., spending balance plus $75 amount).

In step 230, automated balance spending program 142 determines if the total cost of the order list is greater than the spending balance or the max available balance.

If, in step 230, automated balance spending program 142 determines that the total cost of the order list is greater than the spending balance or the max available balance, then in step 232 automated balance spending program 142 may apply a courtesy discount to reduce the total cost of the order list to equal the spending balance or the max available balance.

If, in step 230, automated balance spending program 142 determines that the total cost of the order list is not greater than the spending balance or the max available balance (i.e., is less than or equal to the spending balance or the max available balance), then in step 234 automated balance spending program 142 aggregates all items on the order list and submits or schedules the order. In an exemplary embodiment, automated balance spending program 142 may schedule the order for a future date, for example, such that user 120 may be given the opportunity to cancel the order if desired.

In step 236, automated balance spending program 142 sends an alert or notification to user 120 indicating the order that was submitted or scheduled in step 230. If user 120 does not want the item(s) scheduled for order in step 230, user 120 may cancel the order and the program will proceed back to step 210 removing the item from the purchase list and/or consideration as a relatable affordable item. If user 120 does want the item, user 120 does not need to do anything and the item will be ordered accordingly. Following step 236, the program will proceed back to step 202 wherein automated balance spending program 142 will determine the initial available balance. The updated initial available balance will reflect the recent purchase(s) (i.e., the cost of the purchased item will be subtracted from the previous initial balance).

FIG. 3 shows flow chart 300 depicting operational steps for determining product or item list priority.

In step 302, automated balance spending program 142 receives an input from user 120 including a plurality of items organized by priority. In an exemplary embodiment, the plurality of items may be organized into a plurality of lists, for example, a high priority list, a medium priority list, and a low priority list. Within each list, the items may be organized from most desired to least desired, or highest cost to lowest cost.

In step 304, automated balance spending program 142 removes items with no inventory from the one or more lists.

In step 312, automated balance spending program 142 may receive a customer recommendation item list.

In an exemplary embodiment, to create the customer recommendation item list, in step 306 automated balance spending program 142 may retrieve or receive a first input including at least one of an order history, a return history, one or more product reviews, a favorites history, items saved for later, and onsite browsing history, and other onsite behavior relating to user 120 and/or regional and seasonal trends.

In an exemplary embodiment, to create the customer recommendation item list, in addition or alternative to step 306, in step 308 automated balance spending program 142 may retrieve or receive second input including at least one of medical conditions, personal and family demographic, item category needs, and other customer submitted item guidance related to user 120.

In step 310, automated balance spending program 142 determines the item needs of user 120. In an exemplary embodiment, automated balance spending program 142 may utilize artificial intelligence and/or machine learning to, based on the input received in step 306 and/or step 308, determine which items would be most desired by user 120.

In step 314, automated balance spending program 142 determines the tax for item(s) based on item price and customer address.

To determine the tax for the item(s), in step 316 automated balance spending program 142 receives a shipping address associated with user 120. The shipping address may be inputted manually by user 120 or retrieved automatically by automated balance spending program 142 for example form the account of user 120.

In step 318, automated balance spending program 142 creates a final list organized by priority. The final list may include one or more lists/sub-lists, for example, a first list including high priority items, a second list including medium priority items, and a third list including low priority items. In an exemplary embodiment, the items on each list may be organized by highest cost to lowest cost, including tax.

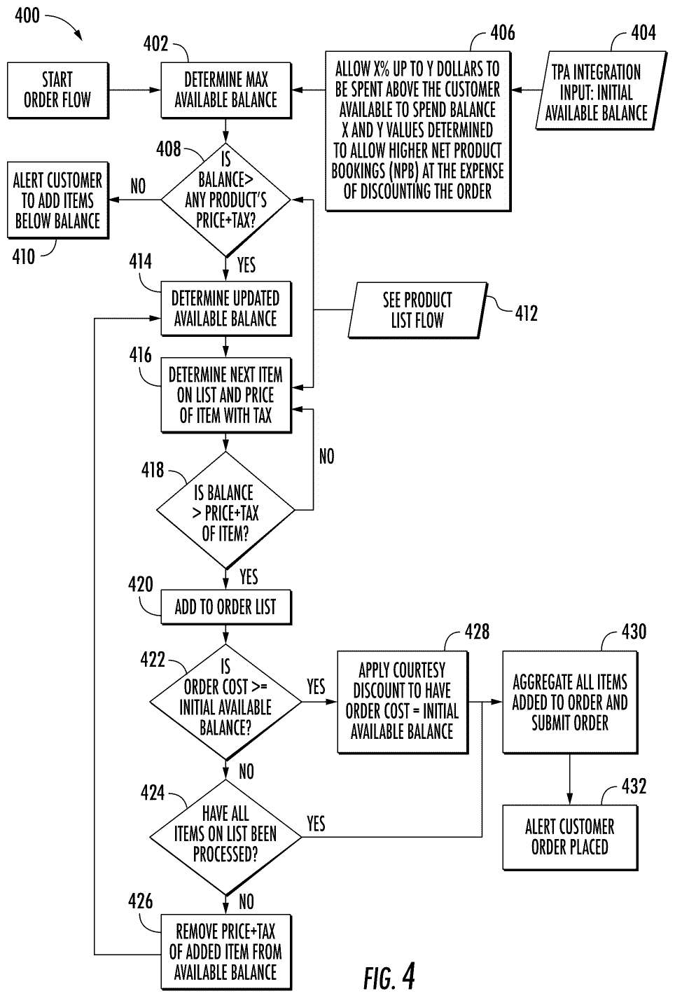

FIG. 4 shows flow chart 400 depicting operational steps for automated balance spending including the application of a courtesy discount.

In step 402, automated balance spending program 142 determines a max available balance. To determine the max available balance, in step 406 automated balance spending program 142 determines an amount to be spent above the initial available balance. For example, automated balance spending program 142 may determine that user 120 may spend over the spending balance by a percentage of the spending balance (e.g., 15%) or an amount (e.g., $75). In an exemplary embodiment, in order to determine an amount to be spent above the available spending balance, in step 404 automated balance spending program 142 receives an input from user 120 indicating the initial available balance and/or an amount to be spent over the available spending balance. This input may be manual (e.g., inputted by user 120 via a GUI) or automatic (e.g., automated balance spending program 142 pulls the amount from the plan). Automated balance spending program 142 may then determine the max available balance. Thus, if user 120 has a spending balance of $1,000, automated balance spending program 142 may determine that the user 120 has a max spending balance of $1,150 (i.e., spending balance plus 15%) or $1,075 (i.e., spending balance plus $75 amount).

In step 408, automated balance spending program 142 determines if the max available balance is greater than a predetermined threshold. Specifically, automated balance spending program 142 determines if user 120 has a max available balance that is greater than a minimum amount, for example, the total of the price of any product on an item list plus the sales tax. In this context, the initial remaining balance is in an account, such as an FSA, HSA, or other such tax-advantaged CDHP account, that must be used by a deadline. In one example, the predetermined threshold is greater than $0. In another example, the predetermined threshold is an amount that correlates to the most inexpensive item offered by HEC retailer 130 (e.g., $8), and thus sufficient to make a purchase. 410 In an exemplary embodiment, step 402 and/or step 408 must occur near the deadline. For example, if the plan year ends on December 31, then automated balance spending program 142 will begin on or after an initiation date, for example, December 17 of that same year. Thus, flowchart 400 may include a step before step 402 and/or step 408, wherein automated balance spending program 142 determines that the current date falls on or after the initiation date.

In an exemplary embodiment, automated balance spending program 142 further determines if a grace period exists. For example, if a grace period of three months exists, then automated balance spending program 142 recalculates the deadline, as March 31 of the following year, and the initiation date, as March 17 of the following year.

If, in step 408, automated balance spending program 142 determines that the max available balance is not greater than the predetermined threshold (i.e., less than or equal to the predetermined threshold), then in step 410 automated balance spending program 142 sends an alert or notification to user 120. In an exemplary embodiment, automated balance spending program 142 may send a notification to user 120 to add items of lesser value to the item list, which would thus lower the predetermined threshold in step 408.

If, in step 408, automated balance spending program 142 determines that the max available balance is greater than the predetermined threshold, then in step 414 automated balance spending program 142 determines a spending balance. In an exemplary embodiment, the spending balance is equal to the max available balance. In an exemplary embodiment, the spending balance is equal to the max available balance less any allowed rollover amount. For example, a FSA plan may allow user 120 to rollover $640 of the current plan year into the subsequent plan year. Thus, if the max available balance was $1,000, then the spending balance would be $360.

In an exemplary embodiment, in order to determine if the max available balance is greater than the predetermined threshold (i.e., the price of a product plus tax), in step 412 automated balance spending program 142 receives one or more purchase lists including items ranked by their priority. The purchase list or lists associated with step 412 may be prepared according to the process previously described with respect to FIG. 3.

In step 416, automated balance spending program 142 determines the cost of the first item on the purchase list, with the cost being the price of the item plus tax.

In step 418, automated balance spending program 142 determines if the cost of the first item is less than or equal to the spending balance.

If, in step 418, automated balance spending program 142 determines that the cost of the first item is not less than or equal to the spending balance (i.e., the cost is greater than the spending balance), then the process proceeds back to step 416 wherein automated balance spending program 142 determines the cost of a subsequent item on the purchase list.

If, in step 418, automated balance spending program 142 determines that the cost of the first (or subsequent) item is less than or equal to the spending balance, then in step 420 automated balance spending program 142 adds the item to an order list.

The purchase list, as previously described, may be a user's wish list, or a compilation of items that user 120 has indicated are of interest or desired. The purchase list may be updated over time, saved in a database or other storage means (e.g., cloud storage), and carry over from year to year. In an exemplary embodiment, the purchase list is ranked from most desired to least desired. Automated balance spending program 142 determines if, based on the spending balance, user 120 can afford the first item (i.e., the most desired item) on the purchase list. In an exemplary embodiment, automated balance spending program 142 assesses every possible combination of items to determine which item has the highest cost that is less than the spending balance. If, in step 418, automated balance spending program 142 determines that user 120 cannot afford the first item on the purchase list (i.e., the spending balance is less than the cost of the first item), then automated balance spending program 142 determines if the user can afford the second or a subsequent item on the purchase list. This process will continue for each item on the purchase list until an item is affordable. For example, if user cannot afford the second item on the purchase list, then automated balance spending program 142 will carry out the analysis of this step with respect to the third item, and then the fourth item, and then the fifth item, etc.

It should be appreciated that in an exemplary embodiment, in step 418, if automated balance spending program 142 determines that user 120 cannot afford the second or any subsequent items on the purchase list (i.e., the spending balance is less than the cost of the subsequent item or items), then automated balance spending program 142 may find a relatable affordable item. A relatable affordable item, as previously described, is one in which user 120 can afford (i.e., the spending balance is greater than or equal to the cost of the relatable affordable item) and relates to the interest of user 120. By relates it is meant that such item may be desired by the user based on past purchases, age, gender, height, weight, medical history (i.e., the user wears eye glasses, has diabetes, has joint problems, etc.), an item related to an item on the purchase list, and/or other factors. In an exemplary embodiment, automated balance spending program 142 determines if an item previously purchased by user 120 is repurchasable. For example, allergy medicine may be determined to be a repurchasable item, and thus automated balance spending program 142 may determine that it is the relatable affordable item. Contrarily, a massage gun may be determined to be a non-repurchasable item, since a user would most likely not need two massage guns, and thus automated balance spending program 142 may determine that it is not the relatable affordable item.

In step 422, automated balance spending program 142 determines if the total cost of the items in the order list is greater than the spending balance.

If, in step 422, automated balance spending program 142 determines that the total cost of the items in the order list is greater than the spending balance, then in step 428 automated balance spending program 142 may apply a courtesy discount to reduce the total cost to equal the spending balance.

If, in step 422, automated balance spending program 142 determines that the total cost of the items in the order list is not greater than the spending balance (i.e., the total cost is less than or equal to the spending balance), then in step 424 automated balance spending program 142 determines if all of the items on the purchase list have been processed.

If, in step 424, automated balance spending program 142 determines that all of the items in the order list have not been processed, then in step 426 automated balance spending program 142 subtracts the cost of the added item (item price plus tax) from the spending balance and the process proceed to step 414 wherein automated balance spending program 142 determines the updated spending balance.

If, in step 424, automated balance spending program 142 determines that all of the items in the order list have been processed, then in step 430 automated balance spending program 142 aggregates all items on the order list and submits or schedules the order. In an exemplary embodiment, automated balance spending program 142 may schedule the order for a future date, for example, such that user 120 may be given the opportunity to cancel the order if desired.

In step 432, automated balance spending program 142 sends an alert or notification to user 120 indicating the order that was submitted or scheduled in step 430. If user 120 does not want the item(s) scheduled for order in step 430, user 120 may cancel the order and the program will proceed back to step 414 removing the item from the purchase list and/or consideration as a relatable affordable item. If user 120 does want the item, user 120 does not need to do anything and the item will be ordered accordingly. Following step 432, the program will proceed back to step 402 wherein automated balance spending program 142 will determine the max available balance. The updated max available balance will reflect the recent purchase(s) (i.e., the cost of the purchased item will be subtracted from the previous max available balance).

FIG. 5 is a block diagram of internal and external components of computing device 300, which is representative of the computing device of FIG. 1, in accordance with an exemplary embodiment of the present disclosure. It should be appreciated that FIG. 5 provides only an illustration of one implementation and does not imply any limitations with regard to the environments in which different embodiments may be implemented. In general, the components illustrated in FIG. 5 are representative of any electronic device capable of executing machine-readable program instructions. Examples of computer systems, environments, and/or configurations that may be represented by the components illustrated in FIG. 5 include, but are not limited to, personal computer systems, server computer systems, thin clients, thick clients, laptop computer systems, tablet computer systems, cellular telephones (i.e., smart phones), multiprocessor systems, microprocessor-based systems, network PCs, minicomputer systems, mainframe computer systems, and distributed cloud computing environments that include any of the above systems or devices.

Computing device 500 includes communications fabric 502, which provides for communications between one or more processing units 504, memory 506, persistent storage 508, communications unit 510, and one or more input/output (I/O) interfaces 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM) 516 and cache memory 518. In general, memory 506 can include any suitable volatile or non-volatile computer readable storage media. Software is stored in persistent storage 508 for execution and/or access by one or more of the respective processors 504 via one or more memories of memory 506.

Persistent storage 508 may include, for example, a plurality of magnetic hard disk drives. Alternatively, or in addition to magnetic hard disk drives, persistent storage 508 can include one or more solid state hard drives, semiconductor storage devices, read-only memories (ROM), erasable programmable read-only memories (EPROM), flash memories, or any other computer readable storage media that is capable of storing program instructions or digital information.

The media used by persistent storage 508 can also be removable. For example, a removable hard drive can be used for persistent storage 508. Other examples include optical and magnetic disks, thumb drives, and smart cards that are inserted into a drive for transfer onto another computer readable storage medium that is also part of persistent storage 508.

Communications unit 510 provides for communications with other computer systems or devices via a network. In this exemplary embodiment, communications unit 510 includes network adapters or interfaces such as a TCP/IP adapter cards, wireless Wi-Fi interface cards, or 3G, 4G, or 5G wireless interface cards or other wired or wireless communications links. The network can comprise, for example, copper wires, optical fibers, wireless transmission, routers, firewalls, switches, gateway computers and/or edge servers. Software and data used to practice embodiments of the present disclosure can be downloaded to computing device 500 through communications unit 510 (i.e., via the Internet, a local area network, or other wide area network). From communications unit 510, the software and data can be loaded onto persistent storage 508.

One or more I/O interfaces 512 allow for input and output of data with other devices that may be connected to computing device 500. For example, I/O interface 512 can provide a connection to one or more external devices 520 such as a keyboard, computer mouse, touch screen, virtual keyboard, touch pad, pointing device, or other human interface devices. External devices 520 can also include portable computer readable storage media such as, for example, thumb drives, portable optical or magnetic disks, and memory cards. I/O interface 512 also connects to display 522.

Display 522 provides a mechanism to display data to a user and can be, for example, a computer monitor. Display 522 can also be an incorporated display and may function as a touch screen, such as a built-in display of a tablet computer.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In an exemplary embodiment, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

100 Automated balance spending environment
110 Network
120 User
130 Health-E commerce (HEC) retailer
140 Computing device
142 Automated balance spending program
200 Flow chart
202 Step
204 Step
206 Step
208 Step
210 Step
212 Step
214 Step
216 Step
218 Step
220 Step
222 Step
224 Step
226 Step
228 Step
230 Step
232 Step
234 Step
236 Step
300 Flow chart
302 Step
304 Step
306 Step
308 Step
310 Step
312 Step
314 Step
316 Step
318 Step
400 Flow chart
402 Step
404 Step
406 Step
408 Step
410 Step
412 Step
414 Step
416 Step
418 Step
420 Step
422 Step
424 Step
426 Step
428 Step
430 Step
432 Step
500 Computing device
502 Communications fabric
504 Processing units
506 Memory
508 Persistent storage
510 Communications unit
512 Input/output (I/O) interfaces
516 Random access memory (RAM)
518 Cache memory
520 External device(s)
522 Display

What is claimed is:

1. A method for automatically spending a balance of an account, comprising:
determining that a remaining balance of the account is greater than a predetermined threshold;
determining a spending balance;
determining that a first item on a purchase list is affordable;
scheduling a first order to purchase the first item; and
sending a first notification of the first order to a user.

2. The method as recited in claim 1, further comprising:
determining that the first item on the purchase list is not affordable;
determining that a subsequent item on the purchase list is affordable;
scheduling a second order to purchase the subsequent item; and
sending a second notification of the second order item to the user.

3. The method as recited in claim 1, further comprising:
determining that the first item on the purchase list is not affordable;
determining that all subsequent items on the purchase list are not affordable;
finding a relatable affordable item;
scheduling a second order to purchase the relatable affordable item; and
sending a second notification of the second order to the user.

4. The method as recited in claim 3, wherein the step of finding the relatable affordable item comprises:
determining that a previously purchased item is a repurchasable item; and
determining that the cost of the previously purchased item is less than or equal to the spending balance.

5. The method as recited in claim 1, wherein the step of determining the spending balance comprises:
determining a carryover amount; and
subtracting the carryover amount from the remaining balance.

6. The method as recited in claim 1, further comprising:
calculating a spending deadline associated with the account;
determining an initiation date, wherein the initiation date occurs prior to the spending deadline; and
initiating the step of determining that the remaining balance of the account is greater than the predetermined threshold on the initiation date.

7. The method as recited in claim 6, wherein the step of calculating the spending deadline comprises:
determining a plan year end date;
adding a plan grace period to the plan year end date.

8. The method as recited in claim 1, wherein the account is a flexible spending account.

9. A computer program product for automatically spending the balance of an account, comprising:
a computer readable storage medium and program instructions stored on the computer readable storage medium, the program instructions comprising:
program instructions to determine that a remaining balance of the account is greater than a predetermined threshold;
program instructions to determine a spending balance;
program instructions to determine that a first item on a purchase list is affordable;
program instructions to schedule a first order to purchase the first item; and
program instructions to send a first notification of the first order to a user.

10. The computer program product as recited in claim 9, wherein the program instructions further comprise:
program instructions to determine that the first item on the purchase list is not affordable;
program instructions to determine that a subsequent item on the purchase list is affordable;
program instructions to schedule a second order to purchase the subsequent item; and
program instructions to send a second notification of the second order item to the user.

11. The computer program product as recited in claim 9, wherein the program instructions further comprise:
program instructions to determine that the first item on the purchase list is not affordable;
program instructions to determine that all subsequent items on the purchase list are not affordable;
program instructions to find a relatable affordable item;
program instructions to schedule a second order to purchase the relatable affordable item; and
program instructions to send a second notification of the second order to the user.

12. The computer program product as recited in claim 11, wherein the program instructions to find the relatable affordable item comprise:
program instructions to determine that a previously purchased item is a repurchasable item; and
program instructions to determine that the cost of the previously purchased item is less than or equal to the spending balance.

13. The computer program product as recited in claim 9, wherein the program instructions to determine the spending balance comprise:
program instructions to determine a carryover amount; and
program instructions to subtract the carryover amount from the remaining balance.

14. The computer program product as recited in claim 9, wherein the program instructions further comprise:
program instructions to calculate a spending deadline associated with the account;
program instructions to determine an initiation date, wherein the initiation date occurs prior to the spending deadline; and
program instructions to initiate the step of determining that the remaining balance of the account is greater than the predetermined threshold on the initiation date.

15. The computer program product as recited in claim 14, wherein the program instructions to calculate the spending deadline comprise:
program instructions to determine a plan year end date; and
program instructions to add a plan grace period to the plan year end date.

16. A computer system for automatically spending the balance of an account, comprising:
one or more computer processors;
one or more computer readable storage media; and
program instructions stored on the computer readable storage media for execution by at least one of the one or more computer processors, the program instructions comprising:
program instructions to determine that a remaining balance of the account is greater than a predetermined threshold;
program instructions to determine a spending balance;
program instructions to determine that a first item on a purchase list is affordable;
program instructions to schedule a first order to purchase the first item; and
program instructions to send a first notification of the first order to a user.

17. The computer system as recited in claim 16, wherein the program instructions further comprise:
program instructions to determine that the first item on the purchase list is not affordable;
program instructions to determine that a subsequent item on the purchase list is affordable;
program instructions to schedule a second order to purchase the subsequent item; and
program instructions to send a second notification of the second order item to the user.

18. The computer system as recited in claim 17, wherein the program instructions further comprise:
program instructions to determine that the first item on the purchase list is not affordable;
program instructions to determine that all subsequent items on the purchase list are not affordable;
program instructions to find a relatable affordable item;
program instructions to schedule a second order to purchase the relatable affordable item; and
program instructions to send a second notification of the second order to the user.

19. The computer system as recited in claim 18, wherein the program instructions to find the relatable affordable item comprise:
program instructions to determine that a previously purchased item is a repurchasable item; and
program instructions to determine that the cost of the previously purchased item is less than or equal to the spending balance.

20. The computer system as recited in claim 16, wherein the program instructions to determine the spending balance comprise:
program instructions to determine a carryover amount; and
program instructions to subtract the carryover amount from the remaining balance.
